(19) United States
(12) Patent Application Publication
(10) Pub. No.: US 2016/0238774 A1
(43) Pub. Date: Aug. 18, 2016

(54) LIGHT GUIDE PLATE, BACKLIGHT UNIT COMPRISING SAME, LIQUID CRYSTAL DISPLAY DEVICE AND OPTICAL SHEET

(71) Applicant: FUJIFILM Corporation, Tokyo (JP)

(72) Inventors: Yoshio KOIKE, Kanagawa (JP); Katsufumi OHMURO, Kanagawa (JP)

(73) Assignee: FUJIFILM Corporation, Tokyo (JP)

(21) Appl. No.: 15/050,598

(22) Filed: Feb. 23, 2016

Related U.S. Application Data
(63) Continuation of application No. PCT/JP2014/072386, filed on Aug. 27, 2014.

(30) Foreign Application Priority Data
Aug. 28, 2013 (JP) 2013-177386

(51) Int. Cl. F21V 8/00

(52) U.S. Cl. CPC G02B 6/005; G02B 6/0051; G02B 6/0055

(57) ABSTRACT

The light guide plate includes a light exit surface from which light incident from an end surface exits, and a back surface facing the light exit surface, in which the light guide plate includes a plurality of diffuse reflection patterns containing an inorganic material on the back surface, arid a quantum dot exists on at least one surface selected from a group consisting of at least the light exit surface, the back surface, and the end surface in the shape of a pattern.

### CROSS-REFERENCE TO RELATED APPLICATIONS

This application is a Continuation of PCT International Application No. PCT/JP2014/072386 filed on Aug. 27, 2014, which claims priority under 35 U.S.C. §119(a) to Japanese Patent Application No. 2013-177386 filed on Aug. 28, 2013. Each of the above applications is hereby expressly incorporated by reference, in its entirety.

### BACKGROUND OF THE INVENTION

1. Field of the invention

The present invention relates to a light guide plate, and specifically, relates to a light guide plate having excellent color purity.

Further, the present invention also relates to a backlight unit including the light guide plate, and a liquid crystal display device including the backlight unit.

Further, the present invention also relates to an optical sheet which is able to be used for preparing the light guide plate described above.

2. Description of the Related Art

A flat panel display such as a liquid crystal display device (hereinafter, also referred to as a liquid crystal display (LCD)) has been variously used as a space saving image display device having low power consumption annually. The liquid crystal display device is configured of at least a backlight and a liquid crystal panel.

An edge light mode backlight and a direct mode backlight have been known as the backlight. The edge light mode backlight is also referred to as a light guide plate mode backlight, and in the edge light mode backlight, light incident from an end surface of a resin plate such as an acrylic plate spreads all over the resin plate by repeating total reflection on the resin plate, and thus the light becomes a surface light source and exits from the entire surface (a light exit surface) of the resin plate on a liquid crystal panel side. Here, in order to realize uniform exit, a method is proposed in which a diffuse reflection pattern of an inorganic material referred to as white ink is disposed on a back surface facing the light exit surface of the resin plate as reflection means (for example, refer to JP2012-178345A).

On the other hand, a low-cost and high-performance LCD has been widely used according to a development in a manufacturing technology and a peripheral related technology of the liquid crystal display. Enhancement in performance has been continuously studied, and an important point for practical application is the total value of performance/cost.

Under such a circumstance, recently, a quantum dot (also referred to as QD and a quantum point) has attracted attention as a light emitting material, and attempts have been made to enhance color purity by using the quantum dot in the LCD, in particular, in the backlight. Specifically, by using the quantum dot as a light conversion material (a color conversion material), (1) arranging the light conversion material, for example, on an upper portion of the light guide plate as a chip-like or sheet-like light conversion member (a color conversion member), (2) mixing the light conversion material into the entire light guide plate, and the like have been performed, and a part of them has been sold as a product (for example, (1) described above refers to JP2012-169271A).

### SUMMARY OF THE INVENTION

In the configuration described above, a separate member is required in (1), and a large amount of quantum dot material is required in (2). For this reason, in the configuration of (1) and (2), the cost may increase compared to the related art. According to this, a novel technology and a novel configuration have been required.

Therefore, an object of the present invention is to provide novel means for enhancing color purity of a liquid crystal display device.

The present inventors have conducted intensive studies in order to attain the object described above. As a result thereof, it has been found that a pattern formed of the quantum dot is disposed on the light guide plate, and thus the object described above is attained. Hereinafter, the finding will he further described.

As described above, a step of forming a pattern of white ink (hereinafter, also referred to as a “white ink pattern forming step”) may be included in a light guide plate preparing process, and the pattern of the quantum dot is formed on the light guide plate on the basis of the white ink pattern forming step, and thus it is possible to realize enhancement in color purity at a low cost by using the light guide plate preparing process without disposing a separate member such as a light conversion member.

Alternatively, it is possible to dispose the pattern of the quantum dot on the light guide plate by a simple step of bonding a quantum dot pattern film in which the pattern of the quantum dot is prepared on a support film onto the resin plate of the light guide plate. In general, the film is at a low price and is also able to be formed by a roll-to-roll (R2R) process, and thus color purity is able to be simply enhanced at a low price.

That is, according to one aspect of the present invention, there is provided a light guide plate including alight exit surface from which light incident from an end surface exits; and a back surface facing the light exit surface, in which the light guide plate includes a plurality of diffuse reflection patterns containing an inorganic material on the back surface, and a quantum dot exists on at least one surface selected from a group consisting of at least the light exit surface, the back surface, and the end surface in the shape of a pattern.

In an embodiment, the quantum dot exists at least on the light exit surface.

In an embodiment, the light guide plate further includes a light guide plate substrate sheet; and a film adjacent to the light guide plate substrate sheet, and the quantum dot exists on a surface of the film on a side opposite to a surface adjacent to the light guide plate substrate sheet in the shape of a pattern.

In an embodiment, the light guide plate further includes a light guide plate substrate sheet, and the quantum dot directly exists on a surface of the light guide plate substrate sheet.

In an embodiment, in the pattern of the quantum dot and the diffuse reflection pattern, at least one selected from a group consisting of a shape, a distribution, a density, and a pattern occupancy area on the surface on which the pattern exists is different.

In an embodiment, the quantum dot exists at least on the light exit surface, and an occupancy area of the pattern of the quantum dot on the light exit surface is greater than an occupancy area of the diffuse reflection pattern on the back surface.

In an embodiment, the quantum dot exists at least on the light exit surface, and a density of the pattern of the quantum dot on the light exit surface is greater than a density of the diffuse reflection pattern on the back surface.

In an embodiment, the quantum dot exists at least on the back surface, and the diffuse reflection pattern exists as an inorganic material coat covering the quantum dot pattern.

In an embodiment, the diffuse reflection pattern thither includes a quantum dot.

In an embodiment, the quantum dot includes a glass covering layer on an uppermost surface.

According to another aspect of the present invention, there is provided a backlight unit including the light guide plate described above; and a light source positioned on an end surface side of the light guide plate.

In an embodiment, the light source is a white light source.

According to still another aspect of the present invention, there is provided a liquid crystal display device including the backlight unit described above; and a liquid crystal panel.

According to still another aspect of the present invention, there is provided an optical sheet in which a quantum dot directly exists on at least one surface of a support film in the shape of a pattern.

According to the aspect of the present invention, it is possible to provide a liquid crystal display device having excellent color purity.

In addition, as described above, the light guide plate is for realizing the surface light source, but when a light amount exiting from the exit surface of the light guide plate considerably varies according to a position, brightness of a display image becomes uneven in the plane. In contrast, according to the aspect of the present invention, it is possible to enhance color purity and to improve in-plane evenness of brightness.

### BRIEF DESCRIPTION OF THE DRAWINGS

FIG. 1 illustrates an example of a light guide plate according to one aspect of the present invention.

FIG. 2 illustrates another example of the light guide plate according to the aspect of the present invention.

FIG. 3 illustrates another example of the light guide plate according to the aspect of the present invention.

FIG. 4 illustrates another example of the light guide plate according to the aspect of the present invention.

FIG. 5 illustrates another example of the light guide plate according to the aspect of the present invention.

FIG. 6 illustrates another example of the light guide plate according to the aspect of the present invention.

FIG. 7 illustrates another example of the light guide plate according to the aspect of the present invention.

FIG. 8 is an explanatory diagram of enhancement in color purity by a backlight unit according to the aspect of the present invention.

FIG. 9 is an explanatory diagram of enhancement in color purity by the backlight unit according to the aspect of the present invention.

FIG. 10 illustrates an example of a liquid crystal display device according to the aspect of the present invention.

FIG. 11 is an explanatory diagram of a liquid crystal display device of the related art.

FIG. 12 is an explanatory diagram of an evaluation method of color purity in an example.

### DESCRIPTION OF THE PREFERRED EMBODIMENTS

[Light Guide Plate]

A light guide plate according to one aspect of the present invention includes a light exit surface from which light incident from an end surface exits, and a back surface facing the light exit surface, the light guide plate includes a plurality of diffuse reflection patterns containing an inorganic material on the back surface, and a quantum dot exists on at least one surface selected from a group consisting of at least the light exit surface, the back surface, and the end surface in the shape of a pattern. By including the pattern of the quantum dot as described above, it is possible to enhance color purity. In addition, by using a light guide plate preparing process or by using a low-cost and simple method of using a support film, it is possible to enhance color purity.

Hereinafter, the light guide plate described above will be described in more detail,

The following description of configuration requirements are based on representative embodiments or specific examples, but the present invention is not limited to the embodiments, Furthermore, herein, “to” indicates a range including the numerical values before and after “to” as the lower limit value and the upper limit value.

In addition, in the present invention and herein, a “half band width” of a peak indicates the width of a peak at ½ of a peak height. In addition, light having an emission center wavelength in a wavelength range of 400 nm to 500 nm, preferably in a wavelength range of 430 nm to 480 nm, will be referred, to as blue light, light having an emission center wavelength in a wavelength range of 500 nm to 600 nm will be referred to as green light, and light having an emission center wavelength in a wavelength range of 600 nm to 680 nm will be referred to as red light.

The light conversion member described above preferably includes a constituent member of a backlight unit of a liquid crystal display device.

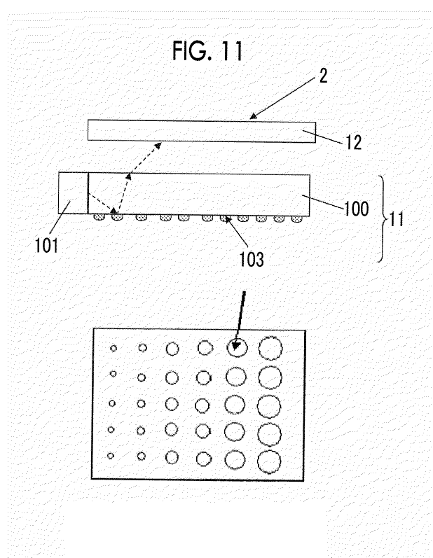

FIG. 11 is an explanatory diagram of a liquid crystal display device of the related art. A liquid crystal display device 2 illustrated in FIG. 11 includes a backlight unit 11 and a liquid crystal panel 12. In addition, various sheets such as a polarizing plate, a diffusion sheet, and a prism sheet are arbitrarily included as a constituent member (not illustrated). The backlight unit 11 is configured of at least a light guide plate substrate sheet (in general, a resin plate such as an acrylic plate) 100, and a light source 101 arranged on an end surface thereof. In addition, a reflection plate or the like is arbitrarily included on a side opposite to the liquid crystal panel as a constituent member (not illustrated).

In the light guide plate substrate sheet 100, a plurality of diffuse reflection patterns 103 are arranged on a surface (a back surface) on a. side opposite to the light exit surface from which light incident from the end surface exits. By including this diffuse reflection pattern 103, the light exiting from the light source 101 and incident on the light guide plate substrate sheet 100 from the end surface is reflected by the diffuse reflection pattern 103 on the light guide plate, for example, as illustrated by a broken line arrow in the drawing, and exits from the light exit surface and is incident on the liquid crystal panel. The plurality of diffuse reflection patterns are disposed on the light guide plate substrate sheet back surface, and thus a surface light source is realized by an incidence ray which is reflected and exits in various directions. In general, the diffuse reflection pattern described above is formed of an inorganic material. As illustrated in FIG. 11, the diffuse reflection patterns on the back surface are arranged to be separated from each other. In general, as illustrated in FIG. 11, a small diffuse reflection pattern is arranged as it is closer to a light source (towards a light source side), and a large diffuse reflection pattern is arranged as being separated from the light source (towards a side opposite to the light source side). The intensity of the light reaching the side opposite to the light source side is weak, and thus strongly reflecting the light by disposing a large diffuse reflection pattern is one effective means for increasing evenness of in-plane brightness.

In contrast, the light guide plate according to the aspect of the present invention includes the plurality of diffuse reflection patterns containing the inorganic material on the back surface, and the quantum dot is arranged on at least one surface of at least the light exit surface, the back surface, and the end surface which is an incidence surface in the shape of a pattern (hereinafter, the pattern including the quantum dot will be referred to as a “quantum dot pattern”). Accordingly, it is possible to enhance color purity by a light conversion (wavelength conversion and color conversion) function of the quantum dot.

Hereinafter, an arrangement example of the quantum dot pattern on the light guide plate according to the aspect of the present invention will be described with reference to the drawings. In the drawings, the lower portion is a back surface side, and the upper portion is a light exit surface side.

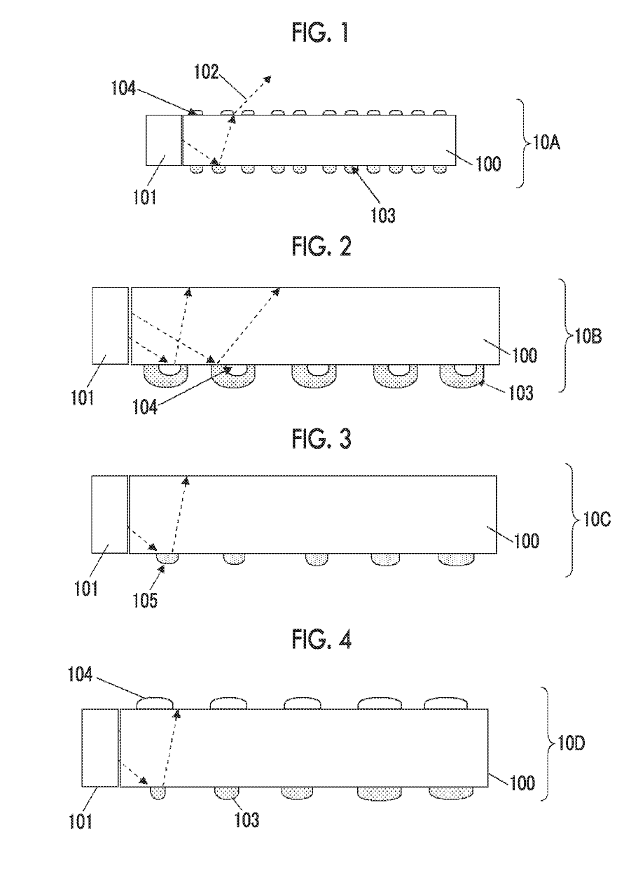

In a light guide plate 10A illustrated in FIG. 1, the plurality of diffuse reflection patterns 103 are arranged on the back surface of the light guide plate substrate sheet 100. The light incident from the end surface of the light guide plate substrate sheet 100 is reflected on a boundary surface between the diffuse reflection pattern 103 and the back surface of the light guide plate substrate sheet 100, or is reflected and diffused, and exits from the exit surface towards the liquid crystal panel. In the drawing, a dotted line arrow 102 indicates an example of a path of such light. Furthermore, in the present invention, the “diffuse reflection pattern” indicates a pattern which at least reflects or diffuses light incident on the pattern, or reflects and diffuses the light.

On the other hand, a plurality of quantum dot patterns 104 are directly arranged on the exit surface of the light guide plate substrate sheet 100 from which the light incident from the end surface exits. Furthermore, in the present invention, the quantum dot pattern being directly arranged on the surface on which the quantum dot pattern exists or the quantum dot pattern directly existing on a certain surface indicates that the quantum dot pattern is directly formed on the surface without using a substrate film or an adhesive layer.

In the diffuse reflection pattern 103 of the light guide plate 10A illustrated in FIG. 1, a plurality of diffuse reflection patterns may be formed in the same size, or as illustrated in FIG. 11, a small diffuse reflection pattern is able to be formed as it is closer to the light source, and a large diffuse reflection pattern is able to be formed as being separated from the light source. In addition, the plurality of diffuse reflection patterns may be evenly formed at equal intervals in the plane, that is, may be formed with the same density in the entire plane. Alternatively, the formation density of the diffuse reflection pattern decreases as it is closer to the light source side and increases as it is closer to the side opposite to the light source side, and thus the same effect as that in a case where a small diffuse reflection pattern is formed as it is closer to the light source side and a large diffuse reflection pattern is formed as it is closer to the side opposite to the light source side is able to be obtained. The details of the formation material or the like of the diffuse reflection pattern will be described below.

The diffuse reflection pattern is arranged. as described above, and the quantum dot pattern 104 may be formed such that a small quantum dot pattern 104 is formed as it is closer to the light source side and a large quantum dot pattern 104 is formed as it is closer to the side opposite to the light source side, or in contrast, may be formed such that a large quantum dot pattern is formed as it is closer to the light source side and a small quantum dot pattern is formed as it is closer to the side opposite to the light source side. Alternatively, all of the quantum dot patterns are able to be formed in the same size, In addition, in the density of the diffuse reflection pattern, the same density may be formed in the entire plane, or the formation density of the diffuse reflection pattern may decrease as it is closer to the light source side and may increase as it is closer to the side opposite to the light source side or may increase as it is closer to the light source side and may decrease as it is closer to the side opposite to the light source side.

The quantum dot includes quantum dots having various light emission properties, and in order to form the quantum dot pattern, one type of quantum dot may be used, or two or more types of quantum dots having different light emission properties may be combined. Examples of a known quantum dot includes a quantum dot (A) having an emission center wavelength in a wavelength range of 600 nm to 680 nm, a quantum dot (B) having an emission center wavelength in a wavelength range of 500 nm to 600 nm, and a quantum dot (C) having an emission center wavelength in a wavelength range of 400 nm to 500 nm, in which the quantum dot (A) is excited by excitation light and emits red light, the quantum dot (B) emits green light, and the quantum dot (C) emits blue light. For example, when a light source emitting blue light is used, the quantum dot (A) emitting the red light and the quantum dot (B) emitting the green light are used as the quantum dot forming the quantum dot pattern, and thus it is possible to embody white light by the blue light from the light source, and the red light and the green light emitted from the quantum dots (A) and (B) excited by the blue light. Alternatively, even when a white light source formed of an LED emitting blue light and a fluorescent body emitting yellow light which has an emission center wavelength in a wavelength range of 570 nm to 585 nm is used, similarly, the quantum dot (A) emitting the red light and the quantum dot (B) emitting the green light are used as the quantum dot forming the quantum dot pattern, and thus it is possible to embody white light by the blue light from the light source, and the red light and the green light emitted from the quantum dots (A) and (B) excited by the light from the light source. Alternatively, when a light source emitting ultraviolet light at a wavelength of 300 nm to 430 nm is used, the quantum dots (A), (B), and (C) are used, and thus it is possible to embody white light by the red light, the green light, and the blue light respectively emitted from three types of quantum dots excited by the ultraviolet light.

In a light guide plate 10B illustrated in FIG. 2, the quantum dot pattern, and the diffuse reflection pattern 103 as inorganic material coat covering the quantum dot pattern are disposed on the back surface of the light guide plate substrate sheet 100. The light incident on the light guide plate substrate sheet 100 from the end surface is reflected by the diffuse reflection pattern 103, and is subjected to wavelength conversion (color conversion) by the quantum dot pattern 104. According to the light guide plate illustrated in FIG. 2, it is possible to improve color purity.

In a light guide plate 10C illustrated in FIG. 3, a plurality of diffuse reflection quantum dot patterns 105 including an inorganic material and a quantum dot are disposed on the back surface of the light guide plate substrate sheet 100. The light guide plate 10C is also able to enhance the color purity by the wavelength conversion (the color conversion) due to the quantum dot.

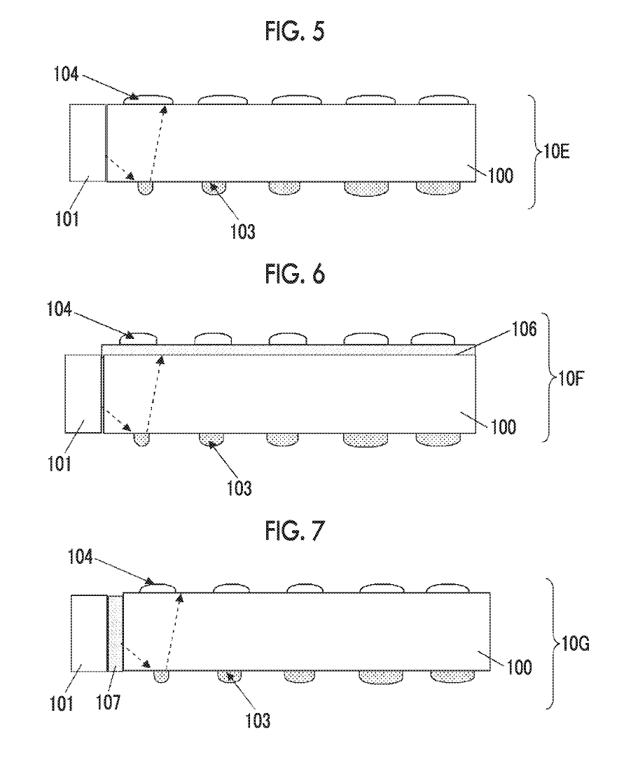

FIG. 4 and FIG. 5 illustrate more specific aspects than the aspect illustrated in FIG. 1.

In a light guide plate 10D illustrated in FIG. 4, the density of the quantum dot pattern on the light exit surface (the density is calculated by “Number of Patterns/Total Area of Surface on Which Pattern is Formed”) is greater than. the density of the diffuse reflection pattern on the back surface.

On the other hand, in alight guide plate 10E illustrated in FIG. 5, as described above, the diffuse reflection pattern on the back surface is formed such that a small diffuse reflection pattern is formed as it is closer to the light source and a large diffuse reflection pattern is formed as it is closer to the side opposite to the light source. In contrast, all of the quantum dot patterns on the light exit surface are formed in the same size. Then, the occupancy area ratio of the quantum dot pattern on the light exit surface (the occupancy area ratio is calculated by “(Total Area of Pattern Total Area of Surface on Which Pattern is Formed)×100”) is greater than the occupancy area of the diffuse reflection dot pattern on the back surface.

In the aspects illustrated in FIG. 4 and FIG. 5, wavelength conversion (color conversion) of an incidence ray due to the quantum dot is more effectively realized by forming more quantum dot patterns (a high density or a large area) than the diffuse reflection pattern.

In all of the aspects described above, it is possible to form the quantum dot pattern in the same step as or the step similar to a forming step of a diffuse reflection pattern of the related art.

Next, a formation method of the diffuse reflection pattern and the quantum dot pattern will be described.

(Quantum Dot)

For example, known quantum dots such as the quantum dots (A), (B), and (C) described above are able to be used as the quantum dot. It is preferable that the type of quantum dot to be used is determined according to the wavelength of the light source, and the specific aspect thereof is as described above. For example, light having a wavelength of 400 nm to a long wavelength is able to be emitted by a quantum dot of ZnSe, CdS CdSe, CdSeTe, PbS, PbSe, and the like, and the quantum dot is able to be used according to the light source to be used. Here, semiconductor nano particles themselves are also able to be used, and it is preferable that a core shell type quantum dot having more excellent stability, light resistance, and light emitting efficiency is used. The core shell type quantum dot is formed by covering the surface of core particles with a covering layer (a shell), and is a quantum dot material from a viewpoint of excellent stability and dispersibility with respect to a solvent. In addition, the surface of the core shell type quantum dot is further covered with a polymer or the like, and thus it is possible to further increase the stability and the dispersibility with respect to a solvent. The core shell type quantum dot is a known core shell type quantum dot, and for example, is disclosed in JP2013-136498A, WO2011/081037A1, and the like. Among them, a quantum dot material disclosed in WO2011/081037A1 in which a glass covering layer is formed on the uppermost surface by applying glass encapsulation thereto is a preferable material at the time of being applied to the aspect of the present invention. Furthermore, light emission properties of the quantum dot are able to be generally controlled by the particle size. In general, light having a short wavelength is emitted as the particle size becomes smaller, and light having along wavelength is emitted as the particle size becomes larger. Two or more types of quantum dots having different light emission properties may be mixed into the same pattern, or a pattern including one type of quantum dot may be formed. In addition, patterns including quantum dots having different light emission properties are able to be respectively disposed on the same surface.

(Inorganic Material)

In general, inorganic materials used as white ink for a light guide plate are able to be used as the inorganic material for forming the diffuse reflection pattern without any limitation. For example, various salts such as an inorganic oxide, a nitride, a carbonate, and a sulfate, and specifically, titanium oxide, calcium carbonate, barium sulfate, and the like are able to be exemplified as the inorganic material. It is preferable that the particle diameter is approximately 200 nm to 400 nm from a viewpoint of dispersibility and diffuse reflection properties, but the present invention is not limited thereto.

(Composition for Forming Pattern)

In general, the diffuse reflection pattern of the light guide plate is formed by applying a photocurable composition onto the hack surface of the light guide plate into the shape of a pattern such as a dot, and then by performing a curing treatment with respect to the photocurable composition by light irradiation. In the aspect of the present invention, the diffuse reflection pattern is able to be formed by a method similar to the general formation method of the diffuse reflection pattern as described above. In general, the photocurable composition described above contains a photocurable compound (a monomer, an oligomer, a prepolymer, and the like) and a photopolymerization initiator. In addition, the photocurable composition may arbitrarily contain various additives Which are generally used. One specific example of the additive is able to include a powder material or a granular substance for adjusting a refraction and scattering function. More specifically, a powder material such as a zinc sulfide powder, a silica powder, and an acrylic resin powder, and a granular substance such as a urethane resin bead, a silicon resin bead, and a glass bead, and the like are able to be suitably used in a suitable amount.

The details of the photocurable composition, for example, are able to refer to paragraphs “0050” to “0054” of JP2012-178345A. The curing conditions may be suitably set according to the type of photocurable component or the like.

Formulation of a known photocurable composition is able to be applied to the composition for forming a pattern for forming the quantum dot pattern as the diffuse reflection composition for forming a pattern. In addition, when the diffuse reflection quantum dot pattern in which the inorganic material and the quantum dot are mixed is formed, a mixing ratio of the inorganic material and the quantum dot in the composition for forming a pattern is not particularly limited.

The composition for forming a pattern is able to be applied by a known printing technology such as an ink jet method, a screen printing method, and a transfer printing method. Among them, the ink jet method is able to eject an arbitrary mount of composition to an arbitrary position, and thus is advantageous from a viewpoint of easily performing fine adjustment such as partially changing the size of the pattern. The ink jet method is also advantageous from a viewpoint of easily changing the pattern according to a program. Furthermore, as illustrated in FIG. 2, in an aspect where the quantum dot pattern is covered with the diffuse reflection pattern, the quantum dot pattern may be applied first, and then the diffuse reflection pattern may be applied.

The pattern to be formed is able to be in an arbitrary shape such as a circle, an ellipse, a square, and a rectangle in a plan view. In addition, when the diffuse reflection pattern and the quantum dot pattern are separately disposed, the shapes of the diffuse reflection pattern and the quantum dot pattern may be identical to each other or different from each other. In addition, patterns having different shapes are able to be formed as the pattern on the same surface. In the size of one pattern, the maximum length (for example, a diameter, a long diameter, and the length of a long side) is approximately 50 μm to 1000 μm, and as described above, the size of the pattern may be changed according to a portion.

The pattern described above is able to be directly formed on the surface of the light guide plate substrate sheet. For example, a commercially available acrylic resin plate, a plate disclosed in paragraph “0023” of JP2011-178345A, or the like is able to be used as the light guide plate substrate sheet. However, in general, a plate used as the resin plate of the light guide plate is able to be used without any limitation, and thus the present invention is not limited thereto. The thickness of the light guide plate substrate sheet, for example, is approximately 0.3 mm to 5 mm, but is not particularly limited.

In the aspect described above, the pattern is directly formed on the surface of the light guide plate substrate sheet, and as described above, a support film on which the quantum dot pattern is formed is bonded to the light guide plate substrate sheet, and thus the quantum dot pattern is able to be disposed on the light guide plate. Hereinafter, the aspect described above will be described with reference to the drawings.

A light guide plate 10F illustrated in FIG. 6 includes the light guide plate substrate sheet 100, and a support film 106 adjacent to the sheet 100. Then, the quantum dot pattern 104 is included on the surface of the support film 106 on a side opposite to the surface adjacent to the light guide plate substrate sheet 100. In general, the support film 106 is indirectly bonded to an exit side surface of the light guide plate substrate sheet 100 through a known adhesive layer (an intermediate layer). However, the light guide plate substrate sheet 100 is able to be directly bonded to the support film 106 by themocompression or the like.

Various materials such as triacetyl cellulose (TAC), polyurethane, polyimide, polyethylene terephthalate (PET), polytetrafluoroethylene (PTFE), polycarbonate, polyamide, an epoxy resin, a silicone resin, and a cycloolefin polymer (COP) are able to be used as the support film, and as necessary, the material of the support film may be selected by including the presence or absence of a phase different. A TAC film and a PET film are preferable as the support films from a viewpoint of transmittance and cost. However, the present invention is not limited thereto. A substrate film which is transparent with respect to visible light is preferable as the substrate film. Here, “transparent with respect to visible light” indicates that light transmittance in a visible region (a wavelength of 380 nm to 780 nm) is greater than or equal to 80%, and is preferably greater than or equal to 85%. The light transmittance used as the scale of transparency is able to be calculated by measuring the total light transmittance and the amount of scattering light using a method disclosed in JIS-K7105, that is, an integrating sphere type light transmittance measurement device, and by deriving diffuse transmittance from the total light transmittance. The thickness of the support film is in a range of 10 μm to 500 μm, is preferably in a range of 10 μm to 200 μm, and is particularly preferably in a range of 20 μm to 100 μm, from a viewpoint of impact resistance, handling in a manufacturing step, and the like. A formation method of the quantum dot pattern onto the surface of the support film is able to be performed by a method similar to a pattern formation method with respect to the surface of the light guide plate substrate sheet. Furthermore, in FIG. 6, an aspect is illustrated in which the support film attached with the quantum dot pattern is disposed on. the exit surface side of the light guide plate substrate sheet, and the diffuse reflection pattern may be disposed on the support film along with the quantum dot pattern. In addition, the diffuse reflection quantum dot pattern described above is also able to be disposed on the support film. Alternatively, the support film on which the diffuse reflection pattern is disposed is bonded to the surface of the light guide plate substrate sheet on the back surface side, and thus the diffuse reflection pattern is also able to be disposed on the back surface side.

In alight guide plate G illustrated in FIG. 7, a support film 107 on which one or more types of a plurality of patterns selected from a group consisting of the diffuse reflection pattern, the quantum dot pattern, and the diffuse reflection quantum dot pattern are formed is arranged on a surface between the light source 101 and the end surface of the light guide plate substrate sheet 100. The pattern described above is formed on a light source side surface of the support film 107. The diffuse reflection pattern has a function of scattering and diffusing light, and the quantum dot pattern and the diffuse reflection quantum dot pattern also have a function of scattering and diffusing light, and thus it is possible to reduce a brightness distribution in the vicinity of the light source by disposing such patterns between the light source and the end surface of the light guide plate substrate sheet. According to this, it is possible to reduce unevenness of brightness which easily occurs on the end surface of the light guide plate, and it is possible to improve the brightness distribution. The pattern described above is able to be formed onto the support film by a method similar to the method described above. In addition, the end surface of the light guide plate substrate sheet is able to be bonded to the support film by a method similar to the method described above.

As described above, the light guide plate according to the aspect of the present invention is described with reference to the drawings, but the present invention is not limited to the aspects illustrated in the drawings or the aspects described above. For example, various modifications such as a combination with a light guide plate technology (a micro reflection (MR) element, an etching molding scattering element, a fine polarization (MD) element, and the like other than the diffuse reflection pattern are able to be performed. In addition, in a manufacturing technology of the light guide plate, when a photocurable resin or thermosetting resin for shape processing using a stamper method is used, a combination with a light guide plate substrate sheet on which a pattern is formed by a manufacturing method of the related art such as direct shape processing by a laser and molding processing by injection is also able to be performed, according to an application technology.

[Backlight Unit]

The backlight unit according to the aspect of the present invention includes the light guide plate described above, and the light source positioned on the end surface side of the light guide plate. The details of the light guide plate are as described above.

(Light Source)

It is preferable that a white light source is able to be used as the light source. Here, white light in the present invention includes not only light which uniformly includes each wavelength component in a visible region (a wavelength 380 nm to 780 nm) but also light which does not uniformly include each of the wavelength components but is seen as white with the naked eye. The white light may include light in a specific wavelength, range, such as red light, green light, and blue light which are reference colors. That is, the white light in the present invention, for example, also includes light including wavelength components from a green color to a red color, light including wavelength components from a blue color to a green color, and the like in a broad sense.

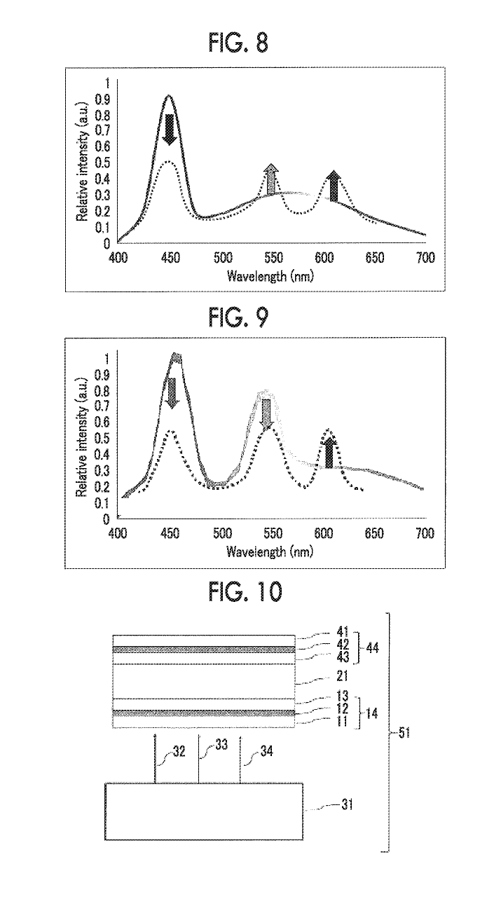

FIG. 8 and FIG. 9 are explanatory diagrams of enhancement in color purity by the backlight unit according to the aspect of the present invention. When a white LED (W-LED), a blue light LED, and a yellow light (Y) fluorescent body are used as an incident light source with respect to the light guide plate, the configuration of the white LED or the like will be described with reference to FIG. 8 and FIG. 9. In an example illustrated in FIG. 8, the quantum dot pattern of the light guide plate is formed of the quantum dot (A emitting the red light and the quantum dot (B) emitting the green light. These quantum dots are excited by the blue light, and thus emit the light having each color described above. Accordingly, the spectrum of the light exiting from the light guide plate generates a peak even in the wavelength region of the green light and the red light as illustrated in FIG. 8, and as a result thereof, color purity is enhanced. In a case of a light source (a blue light (B-) LED, a green light (G-) LED, and the like) in which an incidence ray has a peak in the blue light and the green light, the quantum dot (A) emitting the red light may be basically used as the quantum dot. Accordingly, as illustrated in FIG. 9, a peak is generated even in the wavelength region of the red light, and thus the color purity is enhanced. Thus, it is possible to enhance the color purity by suitably combining the type of light source and a suitable quantum dot having light emission properties according to the type of light source.

(Emission Wavelength of Backlight Unit)

It is preferable that the backlight unit is able to realize high brightness and high color reproducibility by three-wavelength light source, and emits blue light which has an emission center wavelength in a wavelength range of 430 nm to 480 nm and an emission intensity peak having a half band width of less than or equal to 100 nm, green light which has an emission center wavelength in a wavelength range of 500 nm to 600 nm and an emission intensity peak having a half band width of less than or equal to 100 nm, and red light which has an emission center wavelength in a wavelength range of 600 nm to 680 nm and an emission intensity peak having a half band width of less than or equal to 100 nm.

From a viewpoint of further improving brightness and color reproducibility, the wavelength range of the blue light emitted from the backlight unit is preferably 450 nm to 480 nm, and is more preferably 460 nm to 470 nm.

From the same viewpoint, the wavelength range of the green light emitted from the backlight unit is preferably 520 nm to 550 nm, and is more preferably 530 nm to 540 nm.

In addition, from the same viewpoint, the wavelength range of the red light emitted from the backlight unit is preferably 610 nm to 650 nm, and is more preferably 620 nm to 640 nm.

In addition, from the same viewpoint, all of the half band widths of each emission intensity of the blue light, the green light, and the red light emitted from the backlight unit are preferably less than or equal to 80 nm, are more preferably less than or equal to 50 nm, are even more preferably less than or equal to 45 nm, and are still more preferably less than or equal to 40 nm. Among them, it is particularly preferable that the half band widths of each emission intensity of the blue light are less than or equal to 30 nm.

(Configuration of Backlight Unit)

The configuration of the backlight unit is not particularly limited insofar as the backlight unit includes the light guide plate described above. The backlight unit is able to include a reflection member in the rear portion of the light source. Such a reflection member is not particularly limited, but known reflection members disclosed in JP3416302B, JP3363565B, JP4091978B, JP3448626B, and the like are able to be used, and the contents of the publications are incorporated in the present invention.

It is also preferable that the backlight unit includes a wavelength selective filter for a blue color which selectively transmits light having a wavelength shorter than 460 nm among the blue light.

In addition, it is also preferable that the backlight unit includes a wavelength selective filter for a red color which selectively transmits light having a wavelength longer than 630 nm among the red light.

The wavelength selective filter for a blue color or the wavelength selective filter for a red color is not particularly limited, and known wavelength selective filters are able to be used. The filters are disclosed in JP2008-52067A and the like, and the contents of the publication are incorporated in the present invention.

It is also preferable that the backlight unit further include a known diffusion plate or diffusion sheet, a prism sheet (for example, BEF series or the like manufactured by 3M Japan Limited), and alight guide device. These other members are also disclosed in JP3416302B, JP336565B, JP4091978B, JP3448626B, and the like, and the contents of the publications are incorporated in the present invention.

[Liquid. Crystal Display Device]

A liquid crystal display device according to the aspect of the present invention includes at least the backlight unit described above and the liquid crystal panel.

(Configuration of Liquid Crystal Display Device)

The driving display mode of the liquid crystal panel is not particularly limited, and various modes such as a twisted nematic (TN) mode, a super twisted nematic (STN) mode, a vertical alignment (VA) mode, an in-plane switching (IPS) mode, and an optically compensated bend cell (OCB) mode are able to be used. It is preferable that the liquid crystal panel is in a VA mode, an OCB mode, an IPS mode, or a TN mode, but the present invention is not limited thereto. Examples of the configuration of a liquid crystal display device in a VA mode include a configuration illustrated in FIG. 2 of JP2008-262161A. However, a specific configuration of the liquid crystal display device is not particularly limited, but a known configuration is able to be adopted.

In an embodiment of the liquid crystal display device, a liquid crystal panel in which a liquid crystal layer is interposed between facing substrates of which at least one includes an electrode is included, and the liquid crystal cell is configured by being arranged between two polarizing plates. The liquid crystal display device includes the liquid crystal cell in which a liquid crystal is sealed between upper and lower substrates, changes the alignment state of the liquid crystal by applying a voltage, and thus displays an image. Further, as necessary, the liquid crystal display device includes an associated functional layer such as a polarizing plate protective film or an optical compensation member performing optical compensation, and an adhesive layer. In addition, a surface layer such as a forward scattering layer, a primer layer, an antistatic layer, and an undercoat layer may be arranged along with (or instead of) a color filter substrate, a thin layer transistor substrate, a lens film, a diffusion sheet, a hard coat layer, an anti-reflection layer, a low reflection layer, an antiglare layer, and the like.

In FIG. 10, an example of the liquid crystal display device according to the aspect of the present invention is illustrated. A liquid crystal display device 51 illustrated in FIG. 10 includes the backlight side polarizing plate 14 on the surface of the liquid crystal panel 21 on the backlight side. The backlight side polarizing plate 14 may include or may not include the polarizing plate protective film 11 on the surface of the backlight side polarizer 12 on the backlight side, and it is preferable that the backlight side polarizing plate 14 includes the polarizing plate protective film 11 on the surface of the backlight side polarizer 12 on the backlight side.

It is preferable that the backlight side polarizing plate 14 has a configuration in which a polarizer 12 is interposed between two polarizing plate protective films 11 and 13.

Herein, the polarizing plate protective film on a side of the polarizer closer to the liquid crystal panel will be referred to as an inner side polarizing plate protective film, and the polarizing plate protective film on a side of the polarizer separated from the liquid crystal panel will be referred to as an outer side polarizing plate protective film. In an example illustrated in FIG. 11, the polarizing plate protective film 13 is the inner side polarizing plate protective film, and the polarizing plate protective film 11 is the outer side polarizing plate protective film.

The backlight side polarizing plate may include a retardation film as the inner side polarizing plate protective film on the liquid crystal panel side. A known cellulose acylate film or the like is able to be used as the retardation film.

The liquid crystal display device 51 includes a display side polarizing plate 44 on the surface of the liquid crystal panel 21 on a side opposite to the backlight side. The display side polarizing plate 44 has a configuration in which a polarizer 42 is interposed between two polarizing plate protective films 41 and 43. The polarizing plate protective film 43 is the inner side polarizing plate protective film, and the polarizing plate protective film 41 is the outer side polarizing plate protective film.

A backlight unit 31 included in the liquid crystal display device 51 is as described above.

The liquid crystal panel, the polarizing plate, the polarizing plate protective film, and the like configuring the liquid crystal display device according to the aspect of the present invention are not particularly limited, and a liquid crystal panel, a polarizing plate, a polarizing plate protective film, and the like prepared by a known method or commercial products are able to be used without any limitation. In addition, it is also possible to dispose a known intermediate layer such as an adhesive layer between the respective layers.

(Color Filter)

When a light source having an emission center wavelength in a wavelength range of less than or equal to 500 nm is used, various known methods are able to be used as a method of forming an RUB pixel. For example, a photomask is able to be formed on a glass substrate, a desired black matrix is able to be formed thereon by using the photoresist, and a pixel pattern of R, G, B is able to be formed thereon, and an ink composition is discharged by using a printing device of an ink jet method until a desired concentration is obtained in a region (a concave portion surrounded by a convex portion) which is partitioned by a black matrix having a predetermined width and a black matrix having a width wider than that of the black matrix described above at every n black matrix by using a coloring ink for a pixel of R, U, and B, and thus a color filter formed of the pattern of R, U, and B is able to be prepared. After image coloring, each pixel and the black matrix may be completely cured by baking or the like.

Preferred properties of the color filter are disclosed in JP:2008-083611A and the like, and the contents of the publications are incorporated in the present invention.

For example, it is preferable that one wavelength at which the transmittance is half of the maximum transmittance in a color filter exhibiting a green color is greater than or equal to 590 nm and less than or equal to 610 nm, and the other is greater than or equal to 470 nm and less than or equal to 500 nm. In addition, it is preferable that one wavelength at which the transmittance is half of the maximum transmittance in the color filter exhibiting the green color is greater than or equal to 590 nm and less than or equal to 600 nm. Further, it is preferable that the maximum transmittance of the color filter exhibiting the green color is greater than or equal to 80%. It is preferable that a wavelength at which the transmittance is the maximum transmittance in the color filter exhibiting the green color is greater than or equal to 530 nm and less than or equal to 560 nm.

In the color fitter exhibiting the green color, it is preferable that the transmittance at the wavelength of the light emitting peak is less than or equal to 10% of the maximum transmittance.

In a color filter exhibiting a red color, it is preferable that the transmittance at a wavelength of greater than or equal to 580 nm and less than or equal to 590 nm is less than or equal to 10% of the maximum transmittance.

A known pigment is able to be used as a pigment for a color filter without any limitation. Furthermore, currently, the pigment is generally used, but a color filter of a dye may be used insofar as the pigment is a dye which is able to control a spectrum and to ensure process stability and reliability.

(Black Matrix)

In the liquid crystal display device, it is preferable that the black matrix is arranged between the respective pixels. Examples of a material forming a black stripe include a material using a sputtered film of metal such as chromium, a light shielding photosensitive composition in which a photosensitive resin, a black coloring agent, and the like are combined, and the like. Specific examples of the black coloring agent include carbon black, titanium carbon, iron oxide, titanium oxide, graphite, and the like, and among them, the carbon black is preferable.

(Thin Layer Transistor)

It is preferable that the liquid crystal display device further includes a TFT substrate including a thin layer transistor (hereinafter, also referred to as a TFT). It is preferable that the thin layer transistor includes an oxide semiconductor layer having a carrier concentration of less than 1×10¹⁴/cm³. Preferred aspects of the thin layer transistor described above are disclosed in JP2011-141522A, and the contents of the publication are incorporated in the present invention.

The liquid crystal display device according to the aspect of the present invention described above includes the light guide plate described above, and thus it is possible to exhibit high color purity.

[Optical Sheet]

Another aspect of the present invention relates to an optical sheet in which a quantum dot directly exists on at least one surface of the support film in the shape of a pattern. The optical sheet described above is able to be used for preparing the light guide plate according to the aspect of the present invention. The details are as described above.

### EXAMPLES

Hereinafter, the characteristics of the present invention will be more specifically described with reference to examples. Materials, used amounts, ratios, treatment contents, treatment sequences, and the like of the following examples are able to be suitably changed unless the changes cause deviance from the gist of the present invention. Therefore, the range of the present invention will not be restrictively interpreted by the following specific examples.

1. Formulation of Curable Composition for Forming Diffuse Reflection Pattern

Urethane Acrylate Oligomer . . . 20 mass %

Epoxy Acrylate Oligomer . . . 12 mass %

Acryloyl Morpholine . . . 15 mass %

Tripropylene Glycol Diacrylate . . . 15 mass %

Acetophenone-Based Photopolymerization Reaction Initiator . . . 6 mass %

Titanium Oxide Powder (Particle Diameter of 200 nm to 400 nm) . . . 20 mass %

Polyamide Resin Powder . . . 1 mass %

Silicon-Based Antifoaming Agent . . . 2 mass %

2. Quantum Dot Material

A core shell type quantum dot of CdSe/ZnS was used as a quantum dot, and a quantum dot material having a glass capsule size of approximately 100 nm was used as a color conversion material. Glass encapsulation was performed with reference to a method disclosed in WO2011/081037A1. Furthermore, when the excitation wavelength of the quantum clot material used herein was set to 365 nm, the quantum dot material having a particle diameter of 2 nm emitted fluorescent light of blue light, the quantum dot material having a particle diameter of 3 nm emitted fluorescent light of green light, the quantum dot material having a particle diameter of 4 nm emitted fluorescent light of yellow light, and the quantum dot material having a particle diameter of 5 nm emitted fluorescent light of red light. In an example, light from a white light source was incident thereon, and thus the quantum dot emitting the red light and the quantum dot emitting the green light were used by being mixed in the same amount.

3. Formulation of Quantum Dot Composition for Forming Pattern

Urethane Acrylate Oligomer . . . 20 mass %

Epoxy Acrylate Oligomer . . . 20 mass %

Acryloyl Morpholine . . . 15 mass %

Tripropylene Glycol Diacrylate . . . 15 mass %

Acetophenone-Based Polymerization Initiator . . . 5 mass %

Quantum Dot Material (Quantum Dot Glass Capsule) . . . 25 mass %

4. Formulation of Diffuse Reflection Quantum Dot Composition for Forming Pattern

The same formulation as the formulation of 3. described above was used except that the quantum dot material was changed to 25 mass % of a mixture of the titanium oxide powder used in 1. described above and the quantum dot material used in 2. described above at a mass ratio of 2:1. Further in the example, the inorganic material and the quantum dot were mixed at a mixing ratio of 2:1, but the mixing ratio of the materials is able to be suitably adjusted.

5. Light Guide Plate

An acrylic light guide plate for 15 inches (approximately 230 nm×305 nm) was prepared by using a widely used acrylic resin plate as a light guide plate material. The thickness thereof was 2 mm.

6. Support Film

A PET film (a thickness of approximately 100 μm vas used as a support film.

7. Pattern Formation Method

Pattern formation was performed by using a piezo type ink jet device having resolution of 300 dpi. The ejection amount of ink is approximately 30 pL, the ejection amount is controlled by connecting a personal computer (PC) to the ink jet device, and thus an arbitrary amount of ink is able to be ejected onto an arbitrary position.

Furthermore, when the pattern is formed by repeatedly ejecting the ink onto the same position, it is possible to increase the film thickness.

In addition, after the pattern formation, the pattern was irradiated with ultraviolet light of approximately 1 J/m² and was solidified.

Light guide plates of the following examples and comparative examples were prepared by the material, the formulation, and the method described above. Unless otherwise particularly stated, the pattern was randomly arranged in the plane, and all of the patterns were in the shape of a circle. In Example 2, the quantum dot pattern was cured, and then a diffuse reflection pattern larger than the quantum dot pattern was formed on the quantum dot pattern. In addition, the density of each of the patterns on a surface on which the pattern existed was in a range of 20% to 80%.

8. Evaluation Method

In the following evaluation, a commercially available B-YAG type LED light source generating white light by combining a blue color LED and a yttrium-aluminum-garnet fluorescent body (a YAG fluorescent body) was used as a light source.

(1) Evenness of Brightness

Sidelight was mounted on the light guide plates of the examples and the comparative examples as an LED bar, backlight was prepared by arranging one commercially available diffusion sheet on the sidelight, and measurement of brightness was performed. A region was divided into 23 sections in a vertical direction and 30 sections in a horizontal direction, brightness was measured at an intersection position between dividing lines (22×30=660 points in total), and a variation thereof was evaluated.

(2) Color Purity

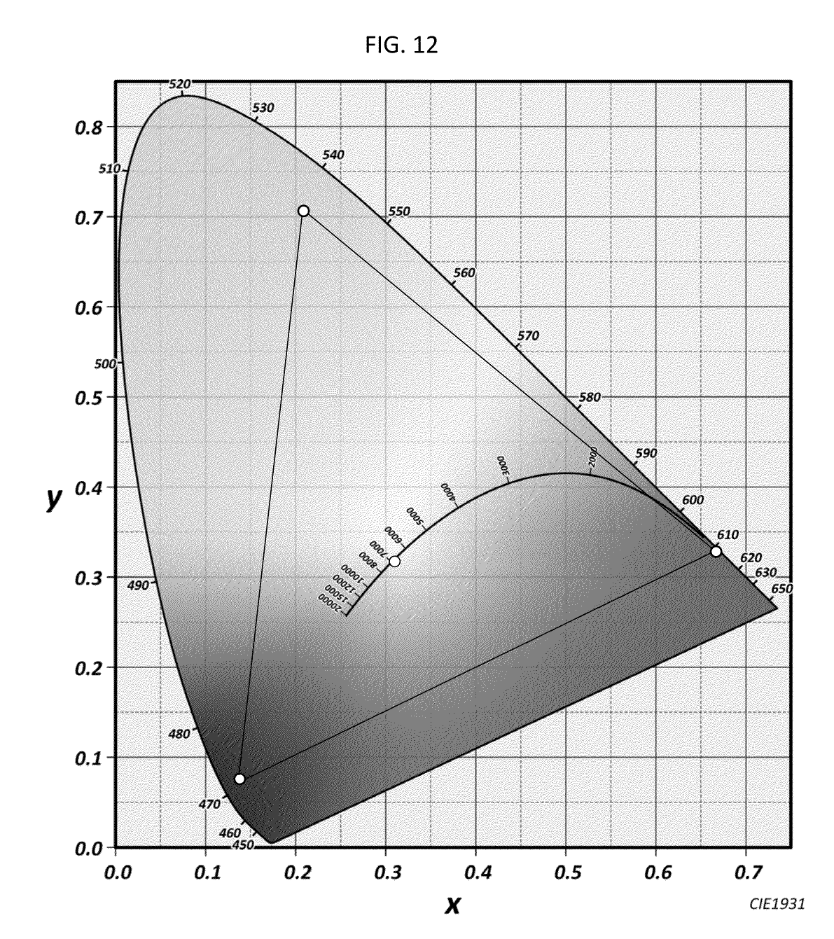

A commercially available 15-inch monitor (TN type) was disassembled, the backlight prepared in (1) described above was arranged, total 9 portions having a length of 3× a width of 3 were measured, an NTSC chromaticity range (a triangle in FIG. 12) was set to 100 by using the average value of the measurement results of the 9 portions, and a color reproduction range with respect to the NTSC chromaticity range was indicated by % and was set to an index of color purity.

[Example 1 (FIG. 1)]

In this example, an occupancy ratio area ratio of the diffuse reflection pattern on a back surface and an occupancy area. ratio of the quantum dot pattern on an exit surface were set to be the same in a range of 40% to 90%. The diameter of the diffuse reflection pattern was in a range of 100 μm to 1 mm, and the diameter of the quantum dot pattern was 50 μm to 500 μm.

[Comparative Example 1]

The light guide plate was prepared and evaluated by the same method as that in Example 1 except that the quantum dot pattern was not formed on the exit surface.

[Example 2 (FIG. 2)]

The diameter of the diffuse reflection pattern was in a range of 100 μm to 1 mm, and the diameter of the quantum dot pattern covered with the diffuse reflection pattern was in a range of 50 μm to 500 μm.

[Example 3 (FIG. 3)]

The occupancy area ratio of the diffuse reflection quantum dot pattern on the back surface was in a range of 10% to 80%, and the diameter of the pattern was in a range of 100 μm to 1 mm.

[Example 4 (FIG. 4)]

The light guide plate was prepared and evaluated by the same method as that in Example 1 except that the size of the quantum dot pattern on the exit surface side was actively changed according to a position. The occupancy area ratio of the diffuse reflection pattern on the back surface was in a range of 10% to 80%, the diameter of the diffuse reflection pattern was in a range of 100 μm to 1 mm, the area occupancy ratio of the quantum dot pattern on the exit surface was in a range of 40% to 90%, and the diameter of the quantum dot pattern was in a range of 50 μmφ to 500 μmφ. it is indicated that the area occupancy ratio, the density, and the pattern size of the quantum dot pattern being larger than the area occupancy ratio, the density, and the pattern size of the diffuse reflection pattern is desirable for enhancement in color purity.

[Example 5 (FIG. 5)]

A large diffuse reflection pattern was formed on the back surface as being separated from the light source such. that the amount of light reflected and diffused on the back surface became approximately uniform on the exit surface side (a diameter of 100 μm to 1 mm), and all of the quantum dot patterns were formed on the exit surface in the same size (a diameter of 1000 μm). The pattern was disposed such that the occupancy area ratio (50%) of the quantum dot pattern on the exit surface was larger than the occupancy area ratio of the diffuse reflection pattern on the back surface. The occupancy area ratio of the quantum dot pattern is larger than the occupancy area ratio of the diffuse reflection pattern, and thus it is possible to increase efficiency of wavelength conversion (color conversion) due to the quantum dot. According to the aspect of the present invention, in brightness and color purity of the liquid crystal display, it is possible to attain further enhancement in in-plane uniformity of brightness and color purity by optimizing the diffuse reflection pattern, the quantum dot pattern, and the shape, the size, the density, and the occupancy area of the diffuse reflection quantum dot pattern.

[Example 6 (FIG. 6)]

The light guide plate was prepared and evaluated by the same method as that in Example 1 except that a quantum dot pattern identical to that in Example 1 was formed on the support of 6. described above on the exit surface side, and the support surface was bonded to the exit surface of the light guide plate by an adhesive agent such that the quantum dot pattern. was arranged on the liquid crystal panel side.

[Example 7 (FIG. 7)]

The light guide plate was prepared and evaluated by the same method as that in Example 1 except that on the support of 6. described above, approximately the same number of quantum dot patterns identical to those in Example 1 and diffuse reflection patterns were prepared such that the occupancy area of the support surface by both of the patterns was in a range of 40% to 90%, and the support surface was bonded to the light guide plate exit surface by an adhesive agent such that the pattern was arranged on the light source side.

The evaluation results of the examples and the comparative examples described above are shown. in Table 1.

TABLE 1

| | Color Purity (with | Brightness |
|---|---|---|
| | respect to NTSC) | Evenness |
| Comparative Example 1 | Approximately 70% | ±30% |
| Example 1 (FIG. 1) | Approximately 80% | ±25% |
| Example 2 (FIG. 2) | Approximately 75% | ±30% |
| Example 3 (FIG. 3) | Approximately 75% | ±30% |
| Example 4 (FIG. 4) | Approximately 85% | ±15% |
| Example 5 (FIG. 5) | Approximately 90% | ±15% |
| Example 6 (FIG. 6) | Approximately 80% | ±25% |
| Example 7 (FIG. 7) | Approximately 90% | ±10% |

From the results shown in Table 1, in the examples, it is possible to confirm that enhancement in color purity is attained. In addition, from the results of Example 1, it is also possible to confirm that color purity is able to be enhanced and evenness of brightness is able to be improved by adjusting the shape, the density, the occupancy area ratio, and the like of the pattern be formed.

According to the aspect of the present invention, it is possible to enhance color purity and to improve brightness by a simple process at a low price, compared to the light guide plate preparing process of the related art.

### INDUSTRIAL APPLICABILITY

An aspect of the present invention is useful in the manufacturing field of a liquid crystal display device.

What is claimed is:

1. A light guide plate, comprising:
a light exit surface from which light incident from au end surface exits; and
a back surface facing the light exit surface,
wherein the light guide plate includes a plurality of diffuse reflection patterns containing an inorganic material on the back surface, and
a quantum dot exists on at least one surface selected from a group consisting of at least the light exit surface, the back surface, and the end surface in the shape of a pattern.

2. The light guide plate according to claim 1,
wherein the quantum dot exists at least on the light exit surface.

3. The light guide plate according to claim 1, further comprising:
a light guide plate substrate sheet; and
a film adjacent to the sheet,
wherein the quantum dot exists on a surface of the film on a side opposite to a surface adjacent to the light guide plate substrate sheet in the shape of a pattern.

4. The light guide plate according to claim 2, further comprising:
a light guide plate substrate sheet; and
a film adjacent to the sheet,
wherein the quantum dot exists on a surface of the film on a side opposite to a surface adjacent to the light guide plate substrate sheet in the shape of a pattern.

5. The light guide plate according to claim 1, further comprising:
a light guide plate substrate sheet,
wherein the quantum clot directly exists on a surface of the light guide plate substrate sheet.

6. The light guide plate according to claim 2, further comprising:
a light guide plate substrate sheet,
wherein the quantum dot directly exists on a surface of the light guide plate substrate sheet.

7. The light guide plate according to claim 1,
wherein in the pattern of the quantum dot and the diffuse reflection pattern, at least one selected from a group consisting of a shape, a distribution, a density, and a pattern occupancy area on the surface on which the pattern exists is different.

8. The light guide plate according to claim 7,
wherein the quantum dot exists at least on the light exit surface, and
an occupancy area of the pattern of the quantum dot on the light exit surface is greater than an occupancy area of the diffuse reflection pattern on the back surface.

9. The light guide plate according to claim 7,
wherein the quantum dot exists at least on the light exit surface, and
a density of the pattern of the quantum dot on the light exit surface is greater than a density of the diffuse reflection pattern on the back surface.

10. The light guide plate according to claim 1,
wherein the quantum dot exists at least on the back surface, and
the diffuse reflection pattern exists as an inorganic material coat covering the quantum dot pattern.

11. The light guide plate according to claim 1,
wherein the diffuse reflection pattern further includes a quantum dot.

12. The light guide plate according to claim 1,
wherein the quantum dot includes a glass covering layer on an uppermost surface.

13. A backlight unit, comprising:
the light guide plate according to claim 1; and
a light source positioned on an end surface side of the light guide plate.

14. The backlight unit according to claim 13,
wherein the light source is a white light source.

15. A liquid crystal display device, comprising;
the backlight unit according to claim 13; and
a liquid crystal panel.

16. An optical sheet in which a quantum dot directly exists on at least one surface of a support film in the shape of a pattern.
